(19) United States
(12) Patent Application Publication
(10) Pub. No.: US 2007/0023048 A1
(43) Pub. Date: Feb. 1, 2007

(54) Cosmetic facial mask

(76) Inventor: Michelle Cho, Irvine, CA (US)

Correspondence Address: MICHAEL A. SHIPPEY, PH. D., 4848 LAKEVIEW AVENUE, SUITE B, YORBA LINDA, CA, 92886, US

(21) Appl. No.: 11/192,230

(22) Filed: Jul. 29, 2005

(51) Int. Cl. A62B 23/02

(52) U.S. Cl. 128/206.19

(57) ABSTRACT

The present invention is a type of mask used for treating the facial area. In its preferred embodiment, it is a one-use, disposable mask. These can be constructed of highly porous surface material enclosing an interior filled with an effusable substance, such as black tea, green tea, herbal tea, herbal essence, chamomile, lavender, eucalyptus, or fruits. The mask is steeped in warm water before use to release the effusable substances.

### BACKGROUND OF THE INVENTION

1. Field of the Invention

The present invention relates to the field of facial masks, and more particularly to herbal therapeutic hydrating masks.

2. Description of Related Art

Some prior art exists in the form of one-piece, disposable facial masks made of cloth or synthetic materials and having cut-outs or slits for the eyes, nose, and mouth. Said masks are sold in a single size using a dimension that is intended to fit a standard size face. They are usually sold pre-infused with a hydrating fluid. The liquids used are water-based agents or extracts of green tea, aloe, or red ginseng.

While the liquids have beneficial ingredients including vitamins, the liquids and the masks suffer from several disadvantages. A major disadvantage is that the liquids made of water-based agents and extracts largely dilute the key ingredients for hydrating the face, thereby lessening the effectiveness of the liquids applied. Of further concern is that the masks are packaged and used at cool to room temperature and cannot be heated. The hydrating ingredients that need to be heated are therefore not released, again rendering the product less effective. The attempt to make a “one-size-fits-all” package also does not work well because of the diversity of shapes and dimensions of the human face, often leaving incomplete coverage of the user's face.

It is also possible to find facial masks that are applied directly to the skin in a clay, peel-off, or mud form. Their primary purpose is to purge the skin of impurities as the mask hardens, and then it is rinsed off. Many of them contain chamomile, lavender, eucalyptus, and fruits, which contain essential oils known to have healing properties when inhaled, but the masks that dry on the face do not allow for the “aromatherapy” aspect of the treatment process because they are nonpermeable. They do not allow the therapeutic aromas to permeate the skin or be inhaled.

Prior art has developed disposable or reusable masks to prevent, medicate, enhance, or treat many conditions that affect the facial area. These include disposable masks to enhance the complexion using clay, mud, cucumber, and avocado. These masks are designed to cleanse the pores of the face to remove impurities and excess oils which clog the pores and can cause blemishes. Some of these disposable masks also firm and refresh the face leaving the complexion looking less stressed. They are applied to the face using fingers and usually originate from a disposable tube or container. The masks are then allowed to dry for a time ranging from 5 minutes to 15 minutes (an approximation) and are either rinsed off or peeled off depending on the type of mask used. However, these disposable masks are limited to improving the complexion of the skin and do nothing to reduce swelling or puffiness around the eyes or cheekbones. They do not relieve injuries in facial muscles from bruises, overexposure to the sun, crying, and other causes of swelling.

Another type of mask used for treating or medicating the facial area is a reusable mask. These can be constructed of nonporous rubber or similar material (Rodelli, U.S. Pat. No. 3,211,146) to apply medications to the face. Other types of reusable masks consist of holes cut out to allow the eyes to see and avoid contact with any medications (Rudo, U.S. Pat. No. 3,354,884). This type of mask is designed primarily to apply pressure to the face to reduce any puffiness or swelling and moisturize utilizing a saturated pad attached to the inside of the mask. Some reusable masks employ electrical-stimulating elements located on the inside of the mask and pressed around key areas, such as the eyes, having an acupuncture-type effect to alleviate headaches or sore muscles. Still, others have focused primarily on moisturizing the face by utilizing straps or fasteners to press lotions or creams onto the face and neck for various lengths of time.

The major drawback of all of the reusable types of masks is that they are uncomfortable and difficult to wear for any extended length of time. Another drawback is that they are not washable, resulting in a short lifespan. For the masks that are used to apply ointments or moisturizers to the face, versatility is limited in that they are designed to apply a certain type of medication or ointment instead of an array of different types.

### BRIEF SUMMARY OF THE INVENTION

The present invention is a type of mask used for treating the facial area. In one preferred embodiment, it is a one-use, disposable mask constructed of a plurality of layers of highly porous surface material enclosing an interior filled with an effusable substance, such as black tea, green tea, herbal tea, herbal essence, chamomile, lavender, eucalyptus, or fruits. The layers of the porous material are attached to each other at the boundary of the mask and in striping across the mask, forming small sections over the entire mask so that the effusable substance within remains evenly distributed across the face. A nose slit is provided for breathing while the mask is laid on the face.

An object of the present invention is to provide a facial mask that allows application of effusable substances that have not been extracted or diluted, and therefore that have retained significant amounts of polyphenols present in the substances for absorption into the skin in sufficient quantities to release higher amounts of anti-aging EGCG in the facial skin.

A further object of the present invention is to provide a facial mask having complete hydrating coverage for the entire surface of a consumer's face, including eyes, nose, and lips, which areas are particularly susceptible to wrinkles, swelling, and dryness causing aging.

A further object of the present invention is to provide a facial mask that can be used to apply hydrating substances found in leaf, stem, and plant matter to facial skin easily and inexpensively without messy application directly to the skin.

It is also an object of the present invention to provide for both warm and cool face hydration by means of a mask that can be steeped in warm water for warm use and, after steeping, refrigerated prior to application for cool use.

Another object of the present invention is to provide a disposable and inexpensive mask that is environmentally friendly.

Other objects and advantages of the present invention will become apparent from the following descriptions, taken in connection with the accompanying drawings, wherein, by way of illustration and example, an embodiment of the present invention is disclosed.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1: Front view of facial mask being applied to a person's face.

FIG. 2: Front view of facial mask with cut-away.

FIG. 3: Side cut-away view of facial mask.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

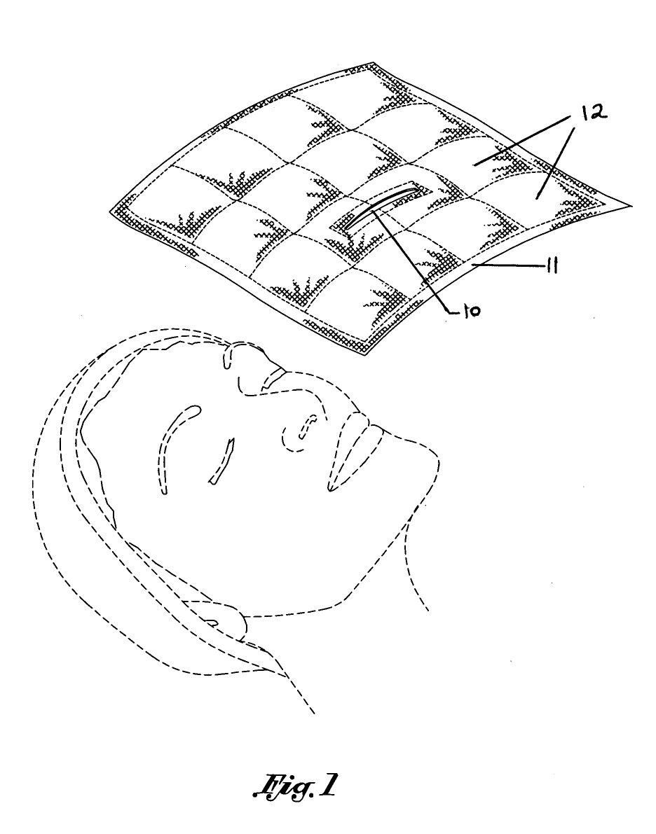

FIG. 1 illustrates a perspective view of the present invention as it is being applied to the face of a person. In this Figure, one can see that the present invention is a face mask roughly rectangular in shape and of sufficient size to cover a person's face from the top of the forehead to the tip of the chin, and to the hairline on either side. The porous material comprising the mask is flexible so that it forms to the contours of the person's face. The mask has an opening for the person's nose 10, allowing comfort in breathing without having to remove the mask or breathe directly through the material. There are no other slits in the mask so that the hydrating effect of the mask can be applied to the entire facial area, including the areas around the eyes and mouth.

The mask is made of several layers, described in detail in FIG. 3, which layers are attached together at the outer boundary 11 by stitching, heat-sealed seaming, or other means. The facial mask is illustrated in its preferred embodiment as comprised of permeable material that is further seamed to create interior compartments 12, each compartment holding effusable substances that contain significant amounts of polyphenols. While it is not required to seam the interior of the mask, the compartmentalization of the mask is important because the smaller sections tend to keep effusable substances inserted into the mask from clustering in one place, allowing it to spread evenly over the face. The leaves, stems, and similar effusable materials will stay more even dispersed across the entire mask even if the user removes and replaces the mask or otherwise moves around while using it. The nose slit is seamed into the mask slightly below center to approximate the usual location of a person's nostrils, typically in the lower one-third of the face.

The effusable substances enclosed in the mask can be any of a plurality of substances that contain significant amounts of polyphenols. An advantage of this type of mask as over the others is its versatility. It can be filled with any ingredients, teas, or herbs that the user prefers, thereby offering a wider selection of treatments and aromas. One common said effusable substance is green tea. Significant scientific research has shown that there are active constituents in green tea, namely, antioxidants called polyphenols (catechins) and flavonols. The absorption of these constituents into the skin releases Epigallocatechin Gallate (EGCG), which inhibits the development of undesirable cell colonies and helps maintain cellular DNA and membrane structural integrity. In the following Figures, portions of the mask are cut-away to illustrate how the tea or other effusable substance is contained within the mask.

A person using this mask needs to release the polyphenols before resting the mask on the face. The procedure for releasing polyphenols is to steep the mask in warm water. Prior to application of the mask to the face, a person may cleanse the face to remove dead skin. While not required, this step is beneficial. Once the mask has steeped for a few minutes, it can be placed on the person's face, preferably while the person is lying in a prone or semi-prone position. Application may be made in a bathtub, in which event if the mask is steeped in the water of the bathtub, it will benefit all of the body skin exposed to the water in which the mask was steeped. If desired, the person can refrigerate the steeped mask and apply it after cooling.

The mask is placed so that the person can breathe through the nose slit. It should be left in place for about 10 minutes to receive full benefit. During this time, the polyphenols will be absorbed into the facial skin in sufficient quantities to release anti-aging (EGCG) into the facial skin. This effect occurs whether the mask is applied warmed or cooled. After usage, the mask can be discarded, the face can be cleansed with water, and the person may apply a moisturizer if desired.

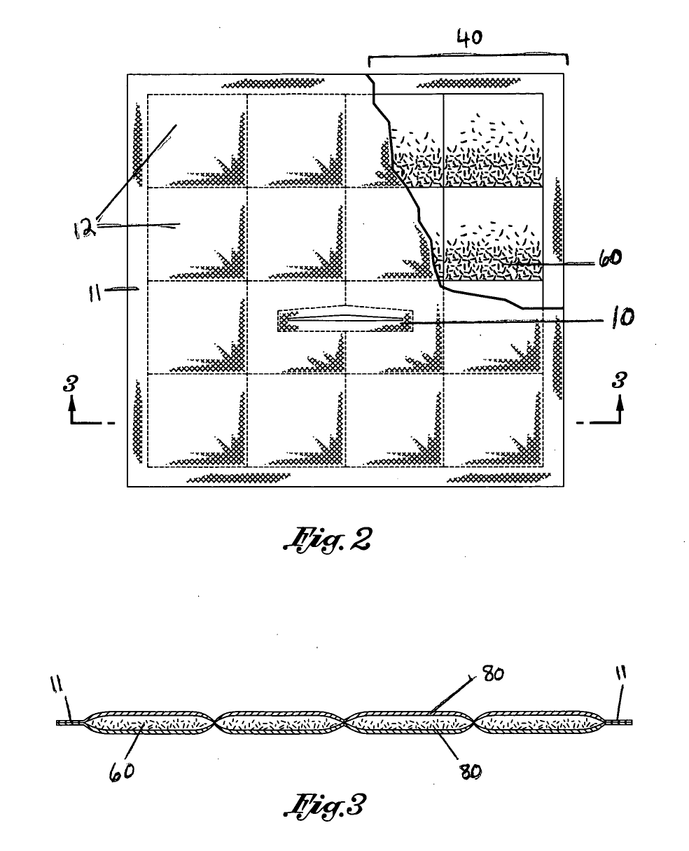

Referring to FIG. 2, the present invention is shown from a frontal view with a cut-away of several compartments 40 to show the inside where the tea or other effusable substance 60 is held. This is an artificial view, as normally the compartments will not be exposed in this fashion. In the disposable embodiment, the compartments are never exposed after filling. In the reusable embodiment, the compartments are exposed only after the mask is used, and being cleaned for reuse.

In FIG. 3, the present invention is shown in the cross-section 3 as notated in FIG. 2. It can be seen that the two layers of permeable material 80 are seamed at the boundaries of the mask 11 and additional interior seaming creates four compartments. Inside each compartment is the loose material consisting of tea or other effusable substance 60 that contains polyphenols. The thin design of the mask is notable, allowing for facile storage and transport.

Permeable material 80 can consist of any suitable material that is permeable to water, but sufficiently closed so as to retain tea leaves or other particulate aromatic feedstock used to charge the mask. Cheesecloth is one example of a suitable material. The paper of tea bags is another. Clearly, permeable paper and the like is better suited for a disposable mask.

In the disposable embodiment, the compartments are filled once, perhaps before the point of sale. The mask is used as described above, then discarded after use.

For the reusable embodiment, the compartments are typically filled and sealed by a resealable attachment along one edge. This can be done at home, with filling chosen by the user. The mask is then steeped and applied in the procedure described above. After the mask is used, it is cleaned of used filling and dirt, and dried for reuse at a later time.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A facial mask, comprising a covering for a human face, said covering comprising a plurality of layers of water-permeable material; said mask having a center layer of effusable substance; said layers being connected along the outer boundaries of the material.

2. The mask of claim 1, wherein the effusable substance is comprised of tea.

3. The mask of claim 1, wherein the effusable substance is comprised of elements from the group consisting of herbal essence, chamomile, lavender, eucalyptus, and fruits.

4. The mask of claim 1, wherein an aperture is made in the approximate center of the covering and of a size sufficient to allow for nasal breathing while the mask is covering the face.

5. The mask of claim 1, wherein the layers are compartmentalized by fixedly connecting them together within the fixed connection along the boundaries of the material.

6. The mask of claim 1, wherein the layers are fixedly connected by sewing.

7. The mask of claim 1, wherein the layers are fixedly connected by heat sealing.

8. The mask of claim 1, wherein the layers are fixedly connected by an adhesive.

9. The mask of claim 1, wherein the covering is rectangular in shape.

10. The mask of claim 1, wherein the covering is ovoid in shape.

11. The mask of claim 1, wherein the covering is circular in shape.

12. The mask of claim 1, wherein the covering is refillable and reusable.

13. The mask of claim 1, wherein the covering is disposable.

14. A process to form the mask of claim 1 wherein the layers of the mask are cut from a sheet of material, then sealed together at the boundaries, leaving at least one side unsealed to allow for insertion of contents, then after insertion of contents, sealed completely at the boundaries.

15. The process of claim 14 wherein the sheets of materials are seamed within the boundaries to create interior compartments.

16. The process of claim 14 wherein the sheets of materials are heat sealed.

17. The process of claim 14 wherein the sheets of materials are seamed by sewing.

18. The process of claim 14 wherein the sheets of materials are seamed by adhesive.

19. The use of the facial mask of claim 1 in the treatment of the face of a person, wherein said mask is soaked in warm water for an effusable-endowing period of time, and then applied to the face of a person.

20. The use of claim 19, wherein after said mask soaked in warm water, the mask is refrigerated for a time sufficient to cool the mask before being applied to the face of a person.
